(19) United States
(12) Patent Application Publication
(10) Pub. No.: US 2024/0195845 A1
(43) Pub. Date: Jun. 13, 2024

(54) CALL CONTROL METHOD AND APPARATUS, STORAGE MEDIUM, AND CHIP

(71) Applicant: Beijing Xiaomi Mobile Software Co., Ltd., Beijing (CN)

(72) Inventors: Tangcan ZHU, Beijing (CN); Tengteng ZHOU, Beijing (CN); Lei CHEN, Beijing (CN)

(21) Appl. No.: 18/301,796

(22) Filed: Apr. 17, 2023

(30) Foreign Application Priority Data
Dec. 13, 2022 (CN) 202211601631.X

(51) Int. Cl. H04L 65/1069; H04L 65/1101; H04W 76/14

(52) U.S. Cl. CPC H04L 65/1069; H04L 65/1101; H04W 76/14

(57) ABSTRACT

A call control method includes: transmitting an incoming call message to an audio processing apparatus through a first application; receiving a first response message returned from the audio processing apparatus based on the incoming call message through the first application, where the first response message includes any one of a first answer message, a first hang-up message, or a first rejection message; and responding to the first response message through the first application, and executing an operation corresponding to the first response message on a second application.

### CROSS REFERENCE TO RELATED APPLICATIONS

The disclosure is provided based on and claims priority to the Chinese Patent Application No. 202211601631.X, filed on Dec. 13, 2022, the entire contents of which are incorporated herein by reference.

### BACKGROUND

In order to satisfy people's demand for the convenience of electronic devices, most headsets on the market have functions of answering, hanging up and rejecting calls, and allow users to answer, hang up and reject calls to terminals accordingly.

### SUMMARY

The disclosure provides a call control method and apparatus, a storage medium, and a chip.

A first aspect of examples of the disclosure provides a call control method. The method is performed by a terminal and includes:
transmitting an incoming call message to an audio processing apparatus through a first application;
receiving a first response message returned from the audio processing apparatus based on the incoming call message through the first application, where the first response message includes any one of a first answer message, a first hang-up message, or a first rejection message; and
responding to the first response message through the first application, and executing an operation corresponding to the first response message on a second application.

A second aspect of examples of the disclosure provides a call control method. The method is performed by an audio processing apparatus and includes:
receiving an incoming call message transmitted from a first application; and
returning a first response message to the first application based on the incoming call message, where the first response message includes any one of a first answer message, a first hang-up message, or a first rejection message, and the first response message is configured to instruct the first application to execute an operation corresponding to the first response message.

A third aspect of examples of the disclosure provides a call control apparatus. The apparatus includes:
a processor, and
a memory configured to store a processor executable instruction,
where the processor is configured to:
implement steps of the call control method according to the first aspect of the examples of the disclosure by executing the executable instruction.

A fourth aspect of examples of the disclosure provides an audio processing apparatus. The apparatus includes:
a processor, and
a memory configured to store a processor executable instruction,
where the processor is configured to:
implement steps of the call control method according to the second aspect of the examples of the disclosure by executing the executable instruction.

A fifth aspect of examples of the disclosure provides a non-transitory computer-readable storage medium, which stores a computer program instruction, where the program instruction implements steps of the call control method according to the first aspect of the disclosure or implements steps of the call control method according to the second aspect of the disclosure when executed by a processor.

A sixth aspect of examples of the disclosure provides a chip, which includes a processor and an interface, where the processor is configured to execute steps of the call control method according to the first aspect of the disclosure or execute steps of the call control method according to the second aspect of the disclosure by reading an instruction.

It is to be understood that the above general description and the following detailed description are merely illustrative and explanatory, and cannot limit the disclosure.

### BRIEF DESCRIPTION OF THE DRAWINGS

The accompanying drawings here are incorporated in the description as a constituent part of the description, illustrate examples conforming to the disclosure and serve to describe principles of the disclosure together with the description.

FIG. 1 is a flow diagram of a call control method according to an example;

FIG. 2 is a schematic diagram of interaction of a call control method according to an example;

FIG. 3 is a schematic diagram of interaction of a call control method according to an example;

FIG. 4 is a schematic diagram of interaction of a call control method according to an example;

FIG. 5 is a flow diagram of a call control method according to an example;

FIG. 6 is a block diagram of a call control apparatus according to an example;

FIG. 7 is a block diagram of a call control apparatus according to an example;

FIG. 8 is a block diagram of a call control apparatus according to an example; and

FIG. 9 is a block diagram of a call control apparatus according to an example.

### DETAILED DESCRIPTION

Examples will be described in detail here and shown in the accompanying drawings illustratively. When the following descriptions involve the accompanying drawings, unless otherwise specified, the same numeral in different accompanying drawings denotes the same or similar elements. The embodiments described in the following examples do not denote all embodiments consistent with the disclosure. On the contrary, the embodiments are merely examples of an apparatus and a method consistent with some aspects of the disclosure as detailed in the appended claims.

It is to be noted that all actions of obtaining signals, information or data in the present application are conducted under the premise of complying with corresponding data protection laws and policies of the current country and obtaining authorization from a corresponding apparatus owner.

The disclosure relates to the technical field of calls, and particularly relates to a call control method and apparatus, a storage medium, and a chip.

In general, users may answer, hang up and reject calls on the terminals through headsets. However, before attending online conferences on various office software or responding to WeChat phone calls with the headsets, the users still have to manually click on office software and enter an interface of the office software for answering, hanging up or rejecting touch operation, which brings inconvenience to the users.

FIG. 1 is a flow diagram of a call control method according to an example. As shown in FIG. 1, the call control method is performed by a terminal and includes steps as follows.

In step S11, an incoming call message is transmitted to an audio processing apparatus through a first application.

The first application may be Miwork, WeChat, Feishu, DingTalk, or other software with audio and video calling functions. The call control method provided in the disclosure may be applied to any software with audio and video calling functions. The audio processing apparatus may be an apparatus for processing audio data, and may not only play audio output from the first application after the first application answers a call, but may collect sound output from a sound source (the sound source may be sound output from a user or another sound source), convert the sound into audio, and transmit the audio to the first application. An audio processing apparatus may be a headset, and the headset may also be a Bluetooth headset or a wired headset.

The incoming call message is a request from a user who uses a second application to make a call with a user who uses the first application. The first application and the second application are of the same type, both of which are WeChat or Miwork for example. The first application and the second application provided in the disclosure are used for indicating that two pieces of software of the same type are configured in different terminals.

For example, terminal A is configured with Miwork (the first application), and terminal B is also configured with Miwork (the second application). When a user uses the Miwork of the terminal B to request a call with the Miwork of the terminal A, Miwork of the terminal A may receive an incoming call message transmitted from the terminal B, the Miwork of the terminal A further transmits the incoming call message to a headset connected with the terminal A, and the headset receives the incoming call message from the terminal B.

In step S12, a first response message returned from the audio processing apparatus based on the incoming call message is received through the first application, where the first response message includes any one of a first answer message, a first hang-up message, or a first rejection message.

After the terminal transmits the incoming call message to the audio processing apparatus through the first application, the user may trigger an answer button and a rejection button on the audio processing apparatus. After the user triggers the answer button to make a voice call, the user may also trigger a hang-up button on the audio processing apparatus. After the user triggers the answer button on the audio processing apparatus, the audio processing apparatus may return the first answer message to the first application. After the user triggers the rejection button on the audio processing apparatus, the audio processing apparatus may return the first rejection message to the first application. After the user triggers the hang-up button on the audio processing apparatus, the audio processing apparatus may return the first hang-up message to the first application.

In the process, the audio processing apparatus directly or further feeds the first answer message, the first rejection message or the first hang-up message back to the first application based on receiving the incoming call message.

The first response message reflects a functional button triggered by the user on the audio processing apparatus.

In step S13, the first application responds to the first response message, and an operation corresponding to the first response message is executed on a second application.

After the terminal receives the first response message through the first application, the operation corresponding to the first response message may be executed through the first application. According to different first different response messages received by the first application, the first application executes different operations.

For example, after the terminal receives the first answer message through the first application, the first application may determine that the audio processing apparatus accepts a call request from the second application. In this case, an answer operation may be executed, the first application is connected with the second application, and further a voice call is made. After the terminal receives the first rejection message through the first application, the first application may determine that the audio processing apparatus rejects a call request from the second application. In this case, a rejection operation may be executed to reject a connection between the first application and the second application.

Through the technical solution, after the terminal transmits the incoming call message to the audio processing apparatus through the first application, the user may trigger the answer button and the rejection button on the audio processing apparatus, and may further trigger the hang-up button after triggering the answer button; the first application may also receive the first response message generated after the user triggers different buttons; and the operation corresponding to the first response message is executed on the second application, such that different call states are achieved.

In a possible embodiment, an entire call flow between the headset and the Miwork may include the following two scenarios, each of which has a different call flow.

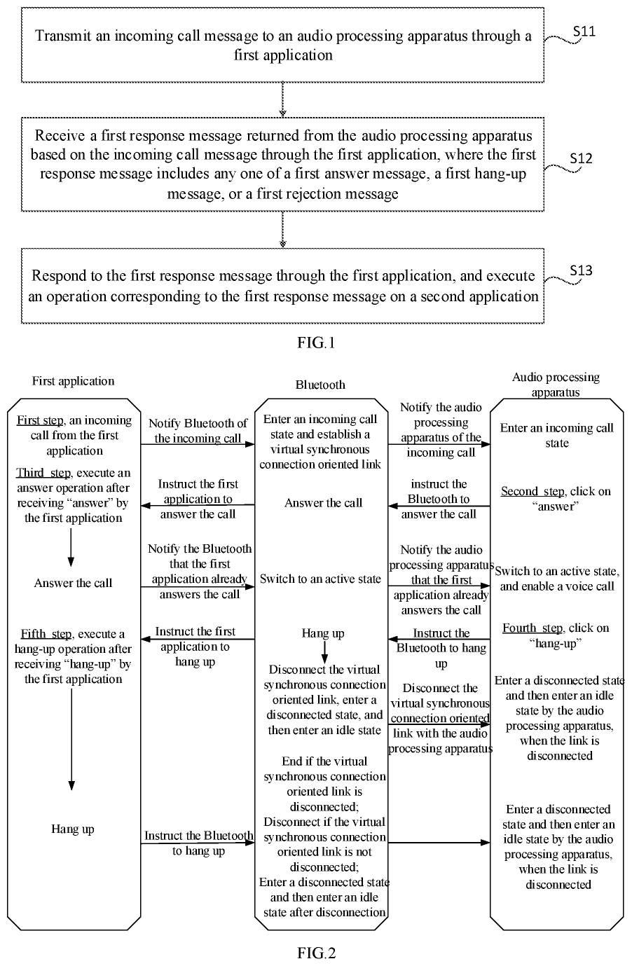

Scenario 1: with reference to FIG. 2, the scenario in which the user answers a call and then hangs up through the audio processing apparatus includes the following flow:
the incoming call message is transmitted to Bluetooth through the first application, where the Bluetooth is configured to synchronize the incoming call message to the audio processing apparatus; and the Bluetooth and the audio processing apparatus establish a virtual synchronous connection oriented link in response to determining that the incoming call message is received.

After the first application receives an incoming call request transmitted from the second application, the first application calls a Bluetooth interface (e.g. an interface provided by Bluetooth headset), and transmits the incoming call message (which is also regarded as an incoming call state) to the Bluetooth through a phone state change function.

When the Bluetooth receives the incoming call message transmitted from the first application, the incoming call message may be synchronized to the audio processing apparatus, and the Bluetooth and the audio processing apparatus may switch from an idle state to the incoming call state in response to the incoming call message. In addition, the Bluetooth and the audio processing apparatus establish the virtual synchronous connection oriented (SCO) link in the incoming call state, and the Bluetooth and the audio processing apparatus may transmit audio data in response to determining that the virtual synchronous connection oriented link is established (a process of transmitting the incoming call message by the first application is a process in which the first application notifies the Bluetooth and the audio processing apparatus of an incoming call in the first step in FIG. 2).

For example, after the Bluetooth and the headset establish a virtual synchronous connection oriented link, the first application transmits an incoming call ring tone to the audio processing apparatus through the Bluetooth, such that a user who wears the audio processing apparatus may hear the incoming call ring tone.

The virtual synchronous connection oriented link is different from a wireless link established between the Bluetooth and the audio processing apparatus. The virtual synchronous connection oriented link is a link temporarily established in response to determining that the Bluetooth and the audio processing apparatus receive the incoming call message. The wireless link is a link established after the user clicks on a device identifier of a target audio processing apparatus on the terminal. After the user executes the rejection operation or the hang-up operation on the audio processing apparatus, the wireless link between the Bluetooth and the headset remains connected, but the virtual synchronous connection oriented link is disconnected. In response to determining that the first application receives the incoming call request next time, the Bluetooth and the audio processing apparatus re-establish the virtual synchronous connection oriented link. Then, it may be understood that every time the first application receives the incoming call request from the second application, the Bluetooth and the audio processing apparatus may be instructed to establish the virtual synchronous connection oriented link.

The link between the Bluetooth and the first application remains connected and cannot be disconnected after the user hangs up the audio processing apparatus, such that the audio processing apparatus may receive the incoming call message from the first application through the Bluetooth in real time.

After the audio processing apparatus switches from the idle state to the incoming call state, the audio processing apparatus may respond to the answer and rejection buttons.

In response to determining that the audio processing apparatus is a Bluetooth headset, that is, a wireless headset, the audio processing apparatus may receive the incoming call message transmitted from the first application through the Bluetooth. In response to determining that the audio processing apparatus is a wired headset, the audio processing apparatus may directly receive the incoming call message transmitted from the first application without establishing the virtual synchronous connection oriented link with the Bluetooth.

The first application is connected with the second application and the audio processing apparatus is instructed to switch to an active state by responding to the first answer message through the first application, where the audio processing apparatus is capable of responding to the hang-up operation of the user in the active state.

In response to determining that the audio processing apparatus is the Bluetooth headset, after the user triggers the answer button on the audio processing apparatus, the audio processing apparatus may transmit the first answer message to the Bluetooth, and the Bluetooth may transmit the first answer message to the first application through broadcasting (a process of transmitting the first answer message by the audio processing apparatus is a process of instructing the Bluetooth and the first application to answer a call in the second step in FIG. 2). In response to determining that the audio processing apparatus is the wired headset, the audio processing apparatus may directly transmit the first answer message to the first application.

After receiving the first answer message, the first application determines that the user agrees to make a call with the user who uses the second application. In this case, the first application may execute the answer operation, that is, the first application may be in communication with the second application. The Bluetooth is notified that the first application is already connected with the second application, and the Bluetooth switches from the incoming call state to the active state. The Bluetooth further notifies the audio processing apparatus that the first application is already connected with the second application, and the audio processing apparatus switches from the incoming call state to the active state. In response to determining that both the Bluetooth and the audio processing apparatus are both in the active state, the Bluetooth and the audio processing apparatus may be configured to transmit audio data (a process in which the first application notifies the Bluetooth and the audio processing apparatus that the first application is already connected with the second application is a process of notifying the Bluetooth and the audio processing apparatus that the first application already answers a call in the third step in FIG. 2).

In this case, audio output from the second application may be transmitted to the audio processing apparatus through the first application and the Bluetooth. Audio collected by the audio processing apparatus may also be transmitted to the second application through the Bluetooth and the first application. In this way, the users of both sides may achieve voice communication by using the first application and the second application.

The audio processing apparatus may call a Bluetooth interface (e.g. an interface provided by Bluetooth headset) and transmit the first answer message to the Bluetooth. After receiving the first answer message, the first application calls the Bluetooth interface (e.g. an interface provided by Bluetooth headset) and notifies the Bluetooth that the first application is already connected with the second application, that is, notifies the Bluetooth that the first application already accepts the incoming call request from the second application.

After the audio processing apparatus switches from the incoming call state to the active state, the audio processing apparatus may respond to the hang-up button, such that the user may hang up at any time.

The first application is disconnected from the second application by responding to the first hang-up message through the first application.

The first application responds to the first hang-up message, the first application is disconnected from the second application, and the Bluetooth may notify the first application of the first hang-up message and also disconnect the virtual synchronous connection oriented link with the audio processing apparatus, such that both the Bluetooth and the audio processing apparatus switch from the active state to a disconnected state, and then switch to the idle state.

For example, after the user triggers the hang-up button of the audio processing apparatus, if the audio processing apparatus is the Bluetooth headset, the audio processing apparatus may transmit the first hang-up message to the Bluetooth and instruct the Bluetooth to hang up, and the Bluetooth may disconnect the virtual synchronous connection oriented link with the audio processing apparatus. After the virtual synchronous connection oriented link is disconnected, both the Bluetooth and the audio processing apparatus may switch from the active state to the disconnected state and then to the idle state. The Bluetooth may transmit the first hang-up message to the first application and instruct the first application to hang up. The first application executes the hang-up operation in response to the first hang-up message, and the first application is disconnected from the second application, such that the call is terminated (a process of transmitting the first hang-up message by the audio processing apparatus is a process of instructing the Bluetooth to hang up by the audio processing apparatus in the fourth step in FIG. 2, and a process of executing the hang-up operation by the first application is a process as shown in the fifth step in FIG. 2).

If the audio processing apparatus is the wired headset, the audio processing apparatus may directly transmit the first hang-up message to the first application, and meanwhile, the audio processing apparatus may automatically switch to the idle state, and further the first application is disconnected from the second application after receiving the first hang-up message.

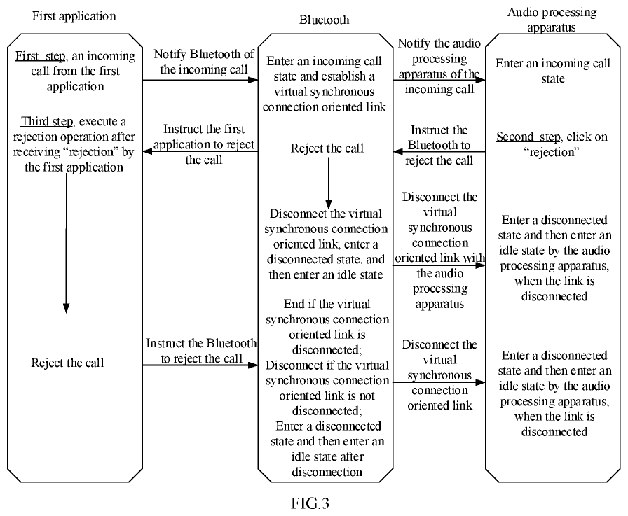

Scenario 2: with reference to FIG. 3, the scenario in which the user rejects a call through the audio processing apparatus includes the following flow:
the incoming call message is transmitted to Bluetooth through the first application, where the Bluetooth is configured to synchronize the incoming call message to the audio processing apparatus; and the Bluetooth and the audio processing apparatus establish a virtual synchronous connection oriented link in response to determining that the incoming call message is received (as shown in the first step in FIG. 3).

On this basis, the users may click on “rejection” as shown in the second step in FIG. 3.

A connection with the second application is rejected by responding to the first rejection message through the first application (as shown in the third step in FIG. 3).

In response to the first rejection message, the first application executes the rejection operation to reject a connection with the second application. In addition, the Bluetooth may automatically disconnect the virtual synchronous connection oriented link with the audio processing apparatus while notifying the first application of the first rejection message. In response to determining that the virtual synchronous connection oriented link is disconnected, both the Bluetooth and the audio processing apparatus switch from the active state to the disconnected state, and then to the idle state.

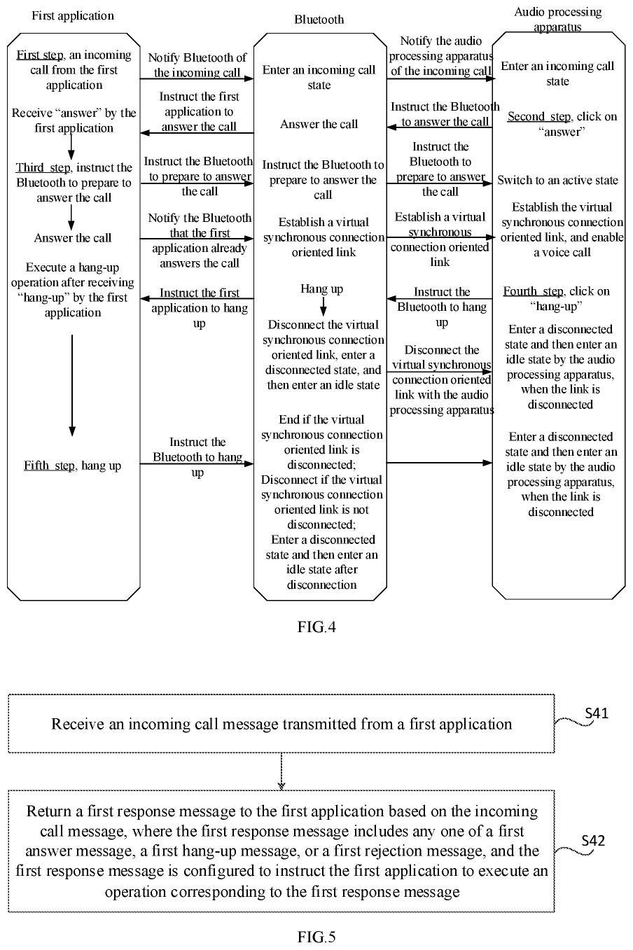

It is to be noted that when studying data interaction between the audio processing apparatus and the first application, the applicant also provides an interaction method shown in FIG. 4, with reference to an answer and hang-up flow of the audio processing apparatus shown in FIG. 4.

First step, the first application first notifies the Bluetooth of an incoming call from the second application, the Bluetooth switches to the incoming call state, then the Bluetooth notifies the audio processing apparatus of the incoming call from the second application, and the audio processing apparatus switches to the incoming call state.

Second step, the user triggers the answer button (clicks on “answer”) on the audio processing apparatus, the audio processing apparatus notifies the Bluetooth that the audio processing apparatus already answers a call, and then the Bluetooth notifies the first application that the audio processing apparatus already answers the call.

Third step, after receiving the answer request, the first application instructs the Bluetooth to prepare to answer the call, the Bluetooth switch from the incoming call state to the active state, the Bluetooth further instructs the audio processing apparatus to prepare to answer the call, and the audio processing apparatus switch from the incoming call state to the active state; and after the first application answers the incoming call from the second application, the Bluetooth and the audio processing apparatus are notified that the first application already answers the call. In this case, the Bluetooth and the headset establish the virtual synchronous connection oriented link, and transmit the audio data based on the virtual synchronous connection oriented link.

Fourth step, the user triggers the hang-up button (clicks on “hang-up”) on the audio processing apparatus, the audio processing apparatus instructs the Bluetooth to hang up, and the Bluetooth instructs the first application to be disconnected from the second application.

Fifth step, the first application executes the hang-up operation.

It may be seen that in the solution shown in FIG. 4, a process of switching the incoming call state and establishing the virtual synchronous connection oriented link is divided into two steps, that is, first step and third step. An evolved solution provided in the disclosure is to switch the incoming call state and establish the virtual synchronous connection oriented link directly in the same step. Compared with the solution, the disclosure omits a flow in which the first application instructs the Bluetooth and the audio processing apparatus to prepare to answer a call. Thus, an interaction flow between the first application and the audio processing apparatus may be further reduced, such that the audio processing apparatus may respond to the audio data output from the first application more quickly.

According to the technical solution, in a first aspect, after the answer button is triggered on the audio processing apparatus, the first answer message may be transmitted to the first application, the terminal responds to the first answer message through the first application, the first application is connected with the second application, and the audio processing apparatus and the Bluetooth are controlled to be in the active state. In this way, the audio data transmitted from the second application may be transmitted to the audio processing apparatus through the first application and the Bluetooth, and the audio data transmitted from the audio processing apparatus may also be transmitted to the second application through the Bluetooth and the first application. Through the process, the user may trigger the first application to answer a call by triggering the answer button of the audio processing apparatus, and after the user triggers the answer button, the first application may be in communication with the second application in response to the answer button triggered by the user.

In a second aspect, after the hang-up button is triggered on the audio processing apparatus, the first hang-up message may be transmitted to the first application, and the terminal may disconnect the first application from the second application by responding to the first hang-up message through the first application. Through the process, the user may trigger the first application to hang up by triggering the hang-up button of the audio processing apparatus, that is, the first application may disconnect communication with the second application in response to the hang-up button triggered by the user on the audio processing apparatus.

In a third aspect, after the rejection button is triggered on the audio processing apparatus, the first rejection message may be transmitted to the first application, and the terminal may reject a connection between the first application and the second application by responding to the first rejection message through the first application. Through the process, the first application may reject the incoming call request from the second application in response to the rejection button of the user, and the user may trigger the rejection button of the audio processing apparatus and also trigger the first application to reject a call.

In a fourth aspect, in the disclosure, in response to determining that the first application notifies the Bluetooth and the audio processing apparatus of an incoming call, the Bluetooth and the audio processing apparatus may establish the virtual synchronous connection oriented link immediately after entering the incoming call state. In this way, the first application may be prevented from creating an extra flow to instruct the Bluetooth and the audio processing apparatus to establish the virtual synchronous connection oriented link, such that the interaction flow between the first application and the audio processing apparatus is reduced, and a response speed of the audio processing apparatus is improved.

In a possible embodiment, the user may not only execute the answer operation, the hang-up operation and the rejection operation on the first application on the audio processing apparatus; and the user may also execute the answer operation, the hang-up operation and the rejection operation on the first application, as detailed in the following steps.

The first application responds to a second response message, and an operation corresponding to the second response message is executed on the second application, where the second response message is a response message generated after the user executes a touch operation on the first application, and the second response message includes any one of a second answer message, a second hang-up message, or a second rejection message.

The first application is connected with the second application and the audio processing apparatus is instructed to switch to an active state by responding to the second answer message through the first application, where the audio processing apparatus is capable of responding to the hang-up operation of the user in the active state.

For example, the second answer message is a message generated after the user triggers the answer button on an interface displayed by the first application, and the first application is connected with the second application in response to the second answer message; and meanwhile, the first application notifies the Bluetooth and the audio processing apparatus that the first application already answers a call, and further the Bluetooth and the audio processing apparatus switch from the incoming call state to the active state.

The first application is disconnected from the second application by responding to the second hang-up message through the first application.

For example, the second hang-up message is a message generated after the user triggers the hang-up button on the interface displayed by the first application, and the first application is disconnected from the second application in response to the second hang-up message.

A connection with the second application is rejected by responding to the second rejection message through the first application.

For example, the second rejection message is a message generated after the user triggers the rejection button on the interface displayed by the first application, and the connection with the second application is rejected by responding to the second rejection message through the first application.

After the first application receives the incoming call request transmitted from the second application, the user may trigger the answer button on the audio processing apparatus, or directly trigger the answer button on the first application so as to accept the incoming call request from the second application; the user may also trigger the hang-up button on the audio processing apparatus, or directly trigger the hang-up button on the first application so as to hang up; and the user may trigger the rejection button on the audio processing apparatus, or directly trigger the rejection button on the first application. The use scenarios depend on actual needs of the user, which are not limited here.

Through the technical solution, the user may not only execute the hang-up, answer and rejection operations of the first application on the audio processing apparatus, or may directly execute the hang-up, answer and rejection operations on the first application, which brings convenience to the user for three-way telephone communication.

In a possible embodiment, with reference to FIGS. 2 and 3, a virtual synchronous connection oriented link between Bluetooth and the audio processing apparatus may be disconnected in two ways as follows:

Way 1: the Bluetooth is instructed to disconnect the virtual synchronous connection oriented link with the audio processing apparatus through the first application, and the audio processing apparatus switches to an idle state in response to determining that the virtual synchronous connection oriented link between the audio processing apparatus and the Bluetooth is disconnected.

In this way, after the user triggers a hang-up button or a rejection button through the audio processing apparatus, the first application receives a first hang-up message or a first rejection message, and instructs the Bluetooth to disconnect the virtual synchronous connection oriented link in response to the first hang-up message or the first rejection message.

It may be understood that in response to determining that the user triggers the hang-up button or the rejection button through the audio processing apparatus, the audio processing apparatus may instruct the Bluetooth to hang up, and the Bluetooth may automatically disconnect the virtual synchronous connection oriented link with the audio processing apparatus. When the Bluetooth receives a hang-up instruction transmitted from the first application again, if the Bluetooth already disconnects the virtual synchronous connection oriented link, the hang-up instruction is not processed; and if the Bluetooth does not disconnect the virtual synchronous connection oriented link, the hang-up instruction is executed so as to disconnect the virtual synchronous connection oriented link.

In this way, after the user triggers the hang-up button or the rejection button on the first application, the first application receives a second hang-up message or a second rejection message, and instructs the Bluetooth to disconnect the virtual synchronous connection oriented link in response to the second hang-up message or the second rejection message.

It may be understood that in response to determining that the user triggers the hang-up button or the rejection button through the first application, the Bluetooth cannot receive a hang-up notification transmitted from the audio processing apparatus because the hang-up or rejection button is not triggered on the audio processing apparatus. In this case, the first application may instruct the Bluetooth to hang up, and the Bluetooth may disconnect the virtual synchronous connection oriented link.

In way 1, the Bluetooth may be instructed to disconnect the virtual synchronous connection oriented link after the first application receives the first hang-up message of the Bluetooth, regardless of whether the user triggers the hang-up button or the rejection button on the audio processing apparatus or trigger the hang-up button or the rejection button on the first application.

Way 2: in response to determining that the user triggers the hang-up button or the rejection button on the first application, the Bluetooth is instructed to disconnect the virtual synchronous connection oriented link with the audio processing apparatus through the first application, and the audio processing apparatus switches to the idle state in response to determining that the virtual synchronous connection oriented link between the audio processing apparatus and the Bluetooth is disconnected.

In this way, if the first application determines that the user triggers the hang-up button or the rejection button on the first application, the first application may instruct the Bluetooth to disconnect the virtual synchronous connection oriented link because the Bluetooth cannot receive the hang-up notification transmitted from the audio processing apparatus; and if the first application determines that the user triggers the hang-up button or the rejection button on the audio processing apparatus, the first application does not need to instruct the Bluetooth to disconnect the virtual synchronous connection oriented link because the audio processing apparatus may instruct the Bluetooth to hang up.

In way 2, whether to instruct the Bluetooth to disconnect the virtual synchronous connection oriented link may be determined by the first application according to situations.

Through the technical solution, when way 1 is used to instruct the Bluetooth to disconnect the virtual synchronous connection oriented link, a logic of instructing the Bluetooth to disconnect the virtual synchronous connection oriented link is simple, such that development cost is reduced. When way 2 is used to instruct the Bluetooth to disconnect the virtual synchronous connection oriented link, the hang-up instruction for disconnecting the link may be transmitted only when the user triggers the hang-up button or the rejection button of the first application, such that the number of times of transmitting the hang-up instruction through the first application is reduced, and further the number of times of interaction between the terminal and the Bluetooth is reduced.

Based on the same inventive concept, with reference to FIG. 5, the disclosure further provides a voice call control method. The method is performed by an audio processing apparatus and includes the following steps:
in step S41, an incoming call message transmitted from a first application is received.

The step is similar to step S11 and will not be described in detail here.

In step S42, a first response message is returned to the first application based on the incoming call message, where the first response message includes any one of a first answer message, a first hang-up message, or a first rejection message, and the first response message is configured to instruct the first application to execute an operation corresponding to the first response message.

The step is similar to step S12 and will not be described in detail here.

Through the technical solution, after the audio processing apparatus receives the incoming call message transmitted from the first application, the user may trigger an answer button and a rejection button on the audio processing apparatus, and may further trigger a hang-up button after triggering the answer button. In this way, different first response messages are generated and fed back to the first application, and further the first application is instructed to execute operations corresponding to the different first response messages, such that different call states are achieved.

In a possible embodiment, the audio processing apparatus and the first application may remotely hang up, answer and reject a call received by the first application through the following steps.

In response to the incoming call message transmitted from the first application through Bluetooth, an incoming call state is entered; and a virtual synchronous connection oriented link is established between the Bluetooth and the audio processing apparatus in response to determining that the Bluetooth and the audio processing apparatus are in an incoming call state.

In response to an answer instruction transmitted from the first application, an active state is switched to, where the audio processing apparatus is capable of responding to a hang-up operation of a user in the active state.

In response to disconnection of the virtual synchronous connection oriented link between Bluetooth and the audio processing apparatus, an idle state is switched to.

The disconnection of the virtual synchronous connection oriented link between the Bluetooth and the audio processing apparatus may occur when the user triggers a hang-up or rejection button on the first application, or triggers a hang-up or rejection button on the audio processing apparatus.

When the virtual synchronous connection oriented link between the Bluetooth and the audio processing apparatus is disconnected, the Bluetooth automatically switches from the active state to the idle state.

It may be understood that when the audio processing apparatus is in the incoming call state, the user may change a call state of the first application by triggering an answer button or the rejection button on the audio processing apparatus; and when the audio processing apparatus is in the active state, the user may change a call state of the first application by triggering the hang-up button on the audio processing apparatus.

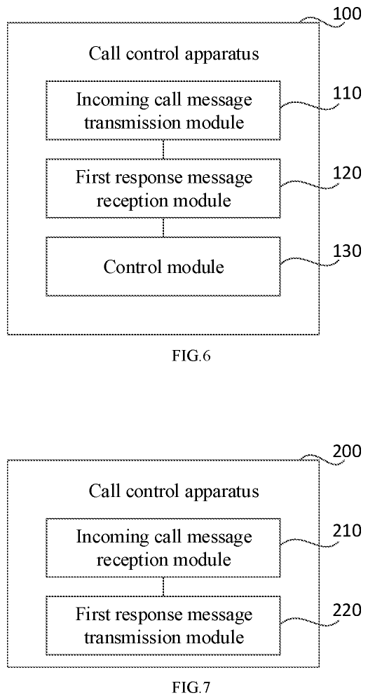

FIG. 6 is a block diagram of a call control apparatus according to an example. The call control apparatus 100 is performed by a terminal. With reference to FIG. 6, the call control apparatus 100 includes: an incoming call message transmission module 110, a first response message reception module 120, and a control module 130.

The incoming call message transmission module 110 is configured to transmit an incoming call message to an audio processing apparatus through a first application.

The first response message reception module 120 is configured to receive a first response message returned from the audio processing apparatus based on the incoming call message through the first application, where the first response message includes any one of an answer message, a hang-up message, or a rejection message.

The control module 130 is configured to respond to the first response message through the first application, and execute an operation corresponding to the first response message on a second application.

Alternatively, the incoming call message transmission module 110 includes:
an incoming call message transmission sub-module configured to transmit the incoming call message to Bluetooth through the first application, where the Bluetooth is configured to synchronize the incoming call message to the audio processing apparatus; and the Bluetooth and the audio processing apparatus establish a virtual synchronous connection oriented link in response to determining that the incoming call message is received.

Alternatively, the control module 130 includes:
a first control sub-module configured to connect the first application with the second application and instructing the audio processing apparatus to switch to an active state by responding to the first answer message through the first application, where the audio processing apparatus is capable of responding to a hang-up operation of a user in the active state.

Alternatively, the control module 130 includes:
a second control sub-module configured to disconnect the first application from the second application by responding to the first hang-up message through the first application.

Alternatively, the control module 130 includes:
a third control sub-module configured to reject a connection with the second application by responding to the first rejection message through the first application.

Alternatively, the call control apparatus 100 includes:
an execution module configured to respond to a second response message through the first application, and execute an operation corresponding to the second response message on the second application, where the second response message is a response message generated after a user executes a touch operation on the first application, and the second response message includes any one of a second answer message, a second hang-up message, or a second rejection message.

Alternatively, the execution module includes:
a first execution sub-module configured to connect the first application with the second application and instruct the audio processing apparatus to switch to the active state by responding to the second answer message through the first application, where the audio processing apparatus is capable of responding to the hang-up operation of the user in the active state.

Alternatively, the execution module includes:
a second execution sub-module configured to disconnect the first application from the second application by responding to the second hang-up message through the first application.

Alternatively, the execution module includes:
a third execution sub-module configured to reject a connection with the second application by responding to the second rejection message through the first application.

Alternatively, the call control apparatus 100 includes:
a disconnection notification module configured to instruct the Bluetooth to disconnect the virtual synchronous connection oriented link with the audio processing apparatus through the first application, where the audio processing apparatus switches to an idle state in response to determining that the virtual synchronous connection oriented link between the audio processing apparatus and the Bluetooth is disconnected.

FIG. 7 is a block diagram of a call control apparatus according to an example. The call control apparatus 200 is performed by an audio processing apparatus. With reference to FIG. 7, the call control apparatus 200 includes: an incoming call message reception module 210 and a first response message transmission module 220.

The incoming call message reception module is configured to receive an incoming call message transmitted from a first application.

The first response message transmission module is configured to return a first response message to the first application based on the incoming call message, where the first response message includes any one of a first answer message, a first hang-up message, or a first rejection message, and the first response message is configured to instruct the first application to execute an operation corresponding to the first response message.

Alternatively, the incoming call message reception module includes:
an incoming call state entering sub-module configured to enter an incoming call state in response to the incoming call message transmitted from the first application through Bluetooth; and
a virtual synchronous connection oriented link establishment sub-module configured to establish a virtual synchronous connection oriented link between the Bluetooth and the audio processing apparatus in response to determining that the Bluetooth and the audio processing apparatus are in the incoming call state.

Alternatively, the call control apparatus 200 includes:
a first switching module configured to switch to an active state in response to an answer instruction transmitted from the first application, where the audio processing apparatus is capable of responding to a hang-up operation of a user in the active state.

Alternatively, the call control apparatus 200 includes:
a second switching module configured to switch to an idle state in response to disconnection of the virtual synchronous connection oriented link between the Bluetooth and the audio processing apparatus.

For the apparatus in the examples described above, its specific implementation for each module to execute an operation is described in detail in the examples relating to the call control method, and will not be described in detail here.

The disclosure further provides a computer-readable storage medium, which stores a computer program instruction, and the program instruction implements the steps of the call control method according to the disclosure when executed by a processor.

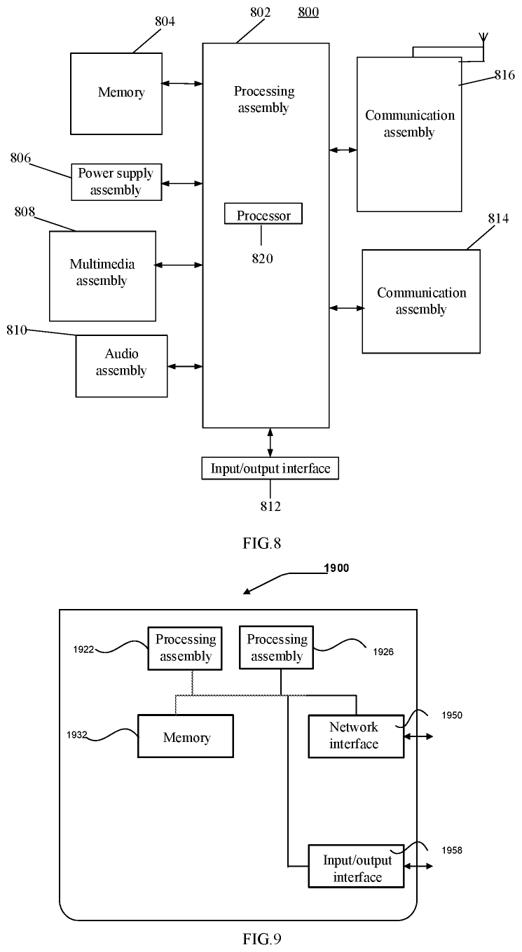

FIG. 8 is a block diagram of a call control apparatus 800 according to an example. For example, the apparatus 800 may be a terminal, such as mobile phone, a computer, a digital broadcast terminal, a messaging device, a game console, a tablet device, a medical device, a fitness device, a personal digital assistant, etc.

With reference to FIG. 8, the apparatus 800 may include one or more of the following assemblies: a processing assembly 802, a memory 804, a power supply assembly 806, a multimedia assembly 808, an audio assembly 810, an input/output interface 812, a sensor assembly 814, and a communication assembly 816.

The processing assembly 802 generally controls all operations of the apparatus 800, such as operations associated with display, telephone call, data communication, camera operation and recording operation. The processing assembly 802 may include one or more processors 820 for executing an instruction, so as to complete all or some steps of the method. In addition, the processing assembly 802 may include one or more modules to facilitate interaction between the processing assembly 802 and other assemblies. For example, the processing assembly 802 may include a multimedia module to facilitate interaction between the multimedia assembly 808 and the processing assembly 802.

The memory 804 is configured to store various types of data, so as to support the operations on the apparatus 800. Examples of the data include an instruction for any first application program or method operating on the apparatus 800, contact data, phone book data, a message, a picture, a video, etc. The memory 804 may be implemented by any type of volatile or nonvolatile memory device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power supply assembly 806 supplies power to various assemblies of the apparatus 800. The power supply assembly 806 may include a power management system, one or more power supplies, and other assemblies associated with generating, managing and distributing power for the apparatus 800.

The multimedia assembly 808 includes a screen that provides an output interface between the apparatus 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, slide and gestures on the touch panel. The touch sensor may sense a boundary of a touch or slide operation, and detect duration and pressure related to the touch or slide operation. In some examples, the multimedia assembly 808 includes a front-facing camera and/or a rear-facing camera. When the apparatus 800 is in an operation mode, such as a shooting mode or a video mode, the front-facing camera and/or the rear-facing camera may receive external multimedia data. Each of the front-facing camera and the rear-facing camera may be a fixed optical lens system or have a focal length and optical zoom capability.

The audio assembly 810 is configured to output and/or input an audio signal. For example, the audio assembly 810 includes a microphone (MIC). The microphone is configured to receive an external audio signal when the apparatus 800 is in operation modes such as a call mode, a recording mode and a speech identification mode. The received audio signal may be further stored in the memory 804 or transmitted via the communication assembly 816. In some examples, the audio assembly 810 further includes a speaker for outputting an audio signal.

The input/output interface 812 provides an interface between the processing assembly 802 and a peripheral interface module. The peripheral interface module may be a keyboard, a click wheel, a button, etc. The buttons may include, but are not limited to, a home button, a volume button, a start button, and a lock button.

The sensor assembly 814 includes one or more sensors for providing various aspects of state assessment for the apparatus 800. For example, the sensor assembly 814 may detect an on/off state of the apparatus 800 and relative positioning of the assemblies such as a display and a keypad of the apparatus 800, and the sensor assembly 814 may further detect position change of the apparatus 800 or an assembly of the apparatus 800, presence or absence of contact between the user and the apparatus 800, an orientation or acceleration/deceleration of the apparatus 800 and temperature change of the apparatus 800. The sensor assembly 814 may include a proximity sensor configured to detect presence of a nearby object without any physical contact. The sensor assembly 814 may further include an optical sensor, such as a complementary metal-oxide-semiconductor (CMOS) or charge-coupled device (CCD) image sensor, which is used in imaging application. In some examples, the sensor assembly 814 may further include an acceleration sensor, a gyroscope sensor, a magnetic sensor, a pressure sensor, or a temperature sensor.

The communication assembly 816 is configured to facilitate wired or wireless communication between the apparatus 800 and other devices. The apparatus 800 may access a wireless network based on a communication standard, such as WiFi, the 2nd generation mobile communication technology (2G) or the 3rd generation mobile communication technology (3G), or their combination. In an example, the communication assembly 816 receives a broadcast signal or broadcast related information from an external broadcast management system via a broadcast channel. In an example, the communication assembly 816 further includes a near field communication (NFC) module to facilitate short-range communication. For example, the NFC module may be implemented based on a radio frequency identification (RFID) technology, an infrared data association (IrDA) technology, an ultra wide band (UWB) technology, a Bluetooth (BT) technology or other technologies.

In an example, the apparatus 800 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic components, thus executing the method.

In an example, there is further provided a non-transitory computer-readable storage medium including an instruction, such as the memory 804 including an instruction. The instruction may be executed by the processor 820 of the apparatus 800 so as to complete the method. For example, the non-transitory computer-readable storage medium may be ROM, a random access memory (RAM), CD-ROM, a magnetic tape, a floppy disk, an optical data storage device, etc.

The apparatus may be an independent electronic device or part of an independent electronic device. For example, in an example, the apparatus may be an integrated circuit (IC) or a chip, where the integrated circuit may be an IC or a collection of a plurality of ICs. The chip may include, but is not limited to, the following types: a graphics processing unit (GPU), a central processing unit (CPU), FPGA, DSP, ASIC, a system on chip (SoC), etc. The integrated circuit or chip may be configured to execute an executable instruction (or a code), so as to implement the call control method. The executable instruction may be stored in the integrated circuit or chip, or may be obtained from other apparatuses or devices. For example, the integrated circuit or chip includes a processor, a memory, and an interface for communication with other apparatuses. The executable instruction may be stored in the memory. The executable instruction implements the call control method when executed by the processor; and alternatively, the integrated circuit or chip may receive the executable instruction through the interface and transmit the instruction to the processor for execution, so as to implement the call control method.

In another example, there is further provided a computer program product, which includes a computer program executable by a programmable apparatus, and the computer program has a code part for executing the call control method when executed by the programmable apparatus.

The disclosure further provides an audio processing apparatus, which includes a processor, and a memory configured to store a processor executable instruction, where the processor is configured to execute the executable instruction to implement the call control method.

FIG. 9 is a block diagram of a call control apparatus 1900 according to an example. For example, a server may be used as the apparatus 1900. With reference to FIG. 9, the apparatus 1900 includes a processing assembly 1922, which further includes one or more processors, and a memory resource represented by a memory 1932, which is configured to store instructions executable by the processing assembly 1922, such as a first application. The first application stored in the memory 1932 may include one or more modules that each corresponds to a group of instructions. In addition, the processing assembly 1922 is configured to execute the instructions, so as to execute the call control method.

The apparatus 1900 may further include a power supply assembly 1926 configured to execute power management of the apparatus 1900, a wired or wireless network interface 1950 configured to connect the apparatus 1900 to a network, and an input/output interface 1958. The apparatus 1900 may operate an operating system stored in the memory 1932.

Those skilled in the art could easily conceive of other implementation solutions of the disclosure upon consideration of the description and practice of the disclosure. The present application is intended to cover any variations, uses or adaptive changes of the disclosure, which follow the general principles of the disclosure and include common general knowledge or conventional technical means not disclosed in the art. The description and the examples are to be regarded as merely illustrative, and the true scope and spirit of the disclosure are indicated by the following claims.

It is to be understood that the disclosure is not limited to a precise structure described above and illustrated in the accompanying drawings, and can have various modifications and changes without departing from the scope. The scope of the disclosure is limited merely by the appended claims.

What is claimed is:

1. A call control method, performed by a terminal and comprising:
transmitting an incoming call message to an audio processing apparatus through a first application;
receiving a first response message returned from the audio processing apparatus based on the incoming call message through the first application, wherein the first response message comprises any one of a first answer message, a first hang-up message, or a first rejection message; and
responding to the first response message through the first application, and executing an operation corresponding to the first response message on a second application.

2. The call control method according to claim 1, wherein transmitting the incoming call message to the audio processing apparatus through the first application comprises:
transmitting the incoming call message to Bluetooth through the first application, wherein the Bluetooth is configured to synchronize the incoming call message to the audio processing apparatus; and the Bluetooth and the audio processing apparatus establish a virtual synchronous connection oriented link in response to determining that the incoming call message is received.

3. The call control method according to claim 1, wherein responding to the first response message through the first application, and executing the operation corresponding to the first response message on the second application comprises:
connecting the first application with the second application and instructing the audio processing apparatus to switch to an active state by responding to the first answer message through the first application, wherein the audio processing apparatus is capable of responding to a hang-up operation of a user in the active state.

4. The call control method according to claim 1, wherein responding to the first response message through the first application, and executing the operation corresponding to the first response message on the second application comprises:
disconnecting the first application from the second application by responding to the first hang-up message through the first application.

5. The call control method according to claim 1, wherein responding to the first response message through the first application, and executing the operation corresponding to the first response message on the second application comprises:
rejecting a connection with the second application by responding to the first rejection message through the first application.

6. The call control method according to claim 1, further comprising:
responding to a second response message through the first application, and executing an operation corresponding to the second response message on the second application, wherein the second response message is a response message generated after a user executes a touch operation on the first application, and the second response message comprises any one of a second answer message, a second hang-up message, or a second rejection message.

7. The call control method according to claim 6, wherein responding to the second response message through the first application, and executing the operation corresponding to the second response message on the second application comprises:
connecting the first application with the second application and instructing the audio processing apparatus to switch to an active state by responding to the second answer message through the first application, wherein the audio processing apparatus is capable of responding to a hang-up operation of the user in the active state.

8. The call control method according to claim 6, wherein responding to the second response message through the first application, and executing the operation corresponding to the second response message on the second application comprises:
disconnecting the first application from the second application by responding to the second hang-up message through the first application.

9. The call control method according to claim 6, wherein responding to the second response message through the first application, and executing the operation corresponding to the second response message on the second application comprises:
rejecting a connection with the second application by responding to the second rejection message through the first application.

10. The call control method according to claim 1, further comprising:
instructing Bluetooth to disconnect a virtual synchronous connection oriented link with the audio processing apparatus through the first application, wherein the audio processing apparatus switches to an idle state in response to determining that the virtual synchronous connection oriented link between the audio processing apparatus and the Bluetooth is disconnected.

11. A call control method, performed by an audio processing apparatus and comprising:
receiving an incoming call message transmitted from a first application; and
returning a first response message to the first application based on the incoming call message, wherein the first response message comprises any one of a first answer message, a first hang-up message, or a first rejection message, and the first response message is configured to instruct the first application to execute an operation corresponding to the first response message.

12. The call control method according to claim 11, wherein receiving the incoming call message transmitted from the first application comprises:
in response to the incoming call message transmitted from the first application through Bluetooth, entering an incoming call state; and
establishing a virtual synchronous connection oriented link between the Bluetooth and the audio processing apparatus in response to determining that the Bluetooth and the audio processing apparatus are in the incoming call state.

13. The call control method according to claim 11, further comprising:
in response to an answer instruction transmitted from the first application, switching to an active state, wherein the audio processing apparatus is capable of responding to a hang-up operation of a user in the active state.

14. The call control method according to claim 11, further comprising:
in response to disconnection of a virtual synchronous connection oriented link between Bluetooth and the audio processing apparatus, switching to an idle state.

15. A call control apparatus, comprising:
a processor, and
a memory configured to store a processor executable instruction,
wherein the processor is configured to:
transmit an incoming call message to an audio processing apparatus through a first application;
receive a first response message returned from the audio processing apparatus based on the incoming call message through the first application, wherein the first response message comprises any one of a first answer message, a first hang-up message, or a first rejection message; and
respond to the first response message through the first application, and execute an operation corresponding to the first response message on a second application.

16. An audio processing apparatus, comprising:
a processor, and
a memory configured to store a processor executable instruction,
wherein the processor is configured to:
implement the call control method according to claim 11 by executing the processor executable instruction.

17. A non-transitory computer-readable storage medium, storing a computer program instruction, wherein a processor is configured to execute the computer program instruction to implement the call control method according to claim 1.

18. A non-transitory computer-readable storage medium, storing a computer program instruction, wherein a processor is configured to execute the computer program instruction to implement the call control method according to claim 11.

19. A chip, comprising a processor and an interface, wherein the processor is configured to execute the call control method according to claim 1 by reading an instruction.

20. A chip, comprising a processor and an interface, wherein the processor is configured to execute the call control method according to claim 11 by reading an instruction.
